(19) United States
(12) Patent Application Publication
(10) Pub. No.: US 2008/0263028 A1
(43) Pub. Date: Oct. 23, 2008

(54) Report Search Method, Report Search System, and Reviewing Apparatus

(75) Inventors: Takehiro Hirai, Ushiku (JP); Kazuo Aoki, Hitachinaka (JP); Naoma Ban, Hitachinaka (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi High-Technologies Corporation, Tokyo (JP)

(21) Appl. No.: 11/969,007

(22) Filed: Jan. 3, 2008

(30) Foreign Application Priority Data
Jan. 4, 2007 (JP) 2007-000020

(51) Int. Cl. G06F 7/06; G06F 17/30

(52) U.S. Cl. 707/5; 707/E17.017

(57) ABSTRACT

An object of the present invention is to provide a report search method, and a reviewing apparatus by which a measure against abnormalities such as a defect of a sample may be quickly obtained by searching desired information in a report recording past information.

In order to achieve the above object, the present invention has a configuration in which an image of a defective appearance and supplementary information on the image are memorized as a report file as one unit in a database for an observation result of the defective appearance of a sample in a manufacturing process, the supplementary information is searched as a search target among a plurality of report files memorized in the database by use of a search condition set from among the supplementary information, when a new defective appearance is generated, and the searched supplementary information and an image related with the supplementary information are output.

### BACKGROUND OF THE INVENTION

1. Field of the Invention

The present invention relates to a method and a system for searching a desired report in a database, and a reviewing apparatus. Especially, the invention, like a reviewing apparatus for semiconductor defects, searches desired information for selection according to the circumstances among various kinds of information such as a defect distribution, images of various kinds of defects, results of X-ray spectrum analysis for defects, results of defect classification to display a report describing the searched information.

2. Description of the Related Art

In the manufacturing process of the semiconductor device, early detection of abnormality and defects, which are caused in each manufacturing processes, and measures against the abnormality and defects are important in order to increase the yield rate of a semiconductor device. Recently, defects influencing the yield rate have become diversified as semiconductor devices become finer. Accordingly, an amount of information required for consideration of the measures has been increased.

The reviewing apparatus observing defects of the semiconductor device is a device acquiring various kinds of information on defects, and a device applying a scanning electron microscope (hereinafter, sometimes called a SEM) has been put into practical use as a finer semiconductor device has been developed. The reviewing apparatus may output: a distribution map for defects on a semiconductor wafer, which is generally called a wafer map; an image (hereinafter, called a SEM image) of an scanning electron microscope; an image (hereinafter, called an OM image) of an optical microscope; an image (hereinafter, called an EDX result) of an X-ray spectrum; a result (hereinafter, called an ADC result) of automatic defect classification; a distribution (hereinafter, called a size distribution) of defect sizes; and the like. Moreover, a magnification of each image, optical conditions at acquisition of an image, a memo paper on which an operator describes comments, and the like are memorized in the reviewing apparatus or a memory device as information.

Here, the defect classification includes manual defect classification by visual observation by a worker, semiautomatic defect classification in which classification is performed automatically to some degree, and detailed classification is performed by a worker. Here, results of defect classification by all the methods including the automatic defect classification are called ADC results.

The defect image and the supplementary information on the analysis result of the defect and the coordinate of the defect are sorted by an operator, using the reviewing apparatus, and are summarized as a report. The above report is made into an electronic file in such a way that the report may be displayed on the display of the reviewing apparatus, or that of a report control server connected to the reviewing apparatus through a network.

There has been a technology by which a SEM image and the supplementary information are summarized as an electronic report file as described in, for example, Japanese Patent Application Laid-Open No. 11-096384. According to the above technology, a report may be simply made by applying a defect image and supplementary information made into texts onto a report with a standard-sized format.

The report not only functions as a statement made when a defect is caused, but preserving the report in a database is useful for cause investigation and measurement consideration when there is caused a defect at a later date.

An image of a defect caused at this time has been displayed on the display of the reviewing apparatus and that of the report control server, and an operator has found an image of a similar defect among past images memorized in the database by his or her own eyes. However, as time and accuracy have become a serious issue by an increase in the number of past images, an increase in defect kinds caused by the finer structure of a semiconductor device, differences in the technical level among operators, and the like, reduction in work loads of operators, shortening of time, and improvement in the search accuracy have been realized by use of the similar image search function in a computer.

As there are various kinds of defects, there is a possibility that there are various kinds of formats of reports, depending on ideas of operators making a report. As an operator is configured to specify supplementary information applied onto a report even in the above-described technology (Japanese Patent Application Laid-Open No. 11-096384), no one can deny a possibility that important data drops out from supplementary information described in a report, even if a past similar image may be searched.

At cause investigation and measurement consideration of a defect, useful information depends on the kind of a defect. For example, when there are a lot of similar defects, there is used a thumbnail image list function in which a lot of images are arranged for comparison, when the shape and the surface properties of a defect are important, an enlarged SEM image is utilized, and, when the material of a defect is important, an EDX result is used. However, for example, when the material of a defect is an important factor for the cause investigation of the defect at this time, the EDX result drops out from the reports preserved in the database to require much labor and time for consideration of measures against defects generated at this time because only supplementary information and images other than the EDX result are used for consideration by an operator. Though it is thought that all information associated with an image of a defect is described in a report, the amount of information is increased for an operator. Accordingly, a difficult-to-use report is obtained to require much more labor and time.

### SUMMARY OF THE INVENTION

An object of the present invention is to provide a report search method, a report search system, and a reviewing apparatus by which a measure against abnormalities such as defects may be quickly obtained by searching desired information in a report recording past information.

In order to realize the above-described object, a report search method according to an embodiment of the present invention has a feature that an image having a defective appearance and supplementary information on the image are memorized as a unit of a report file in a database for an observation result of a defective appearance at a manufacturing process, and, when a new defective appearance is generated, the above-described supplementary information is searched as a search target from among a plurality of report files memorized in the above-described database, using a search condition set from among the above-described supplementary information, and the above-described searched supplementary information and an image related with the above-described supplementary information are output.

According to the present invention, there may be obtained a report search method, a report search system, and a reviewing apparatus, by which a measure against abnormalities such as defects may be quickly obtained by searching desired information in a report recording past information.

### BRIEF DESCRIPTION OF THE DRAWINGS

FIG. 1 is a cross section showing a principal configuration of a SEM type defect reviewing apparatus;

FIG. 2 is a view of a system configuration connecting a plurality of defect reviewing apparatuses;

FIG. 3 is an explanatory view showing the contents of a report file;

FIG. 4 is a flow chart showing the procedures of report search;

FIG. 5 is a screen view showing one example for displaying setting search conditions;

FIG. 6 is a screen view showing one example for displaying setting search conditions;

FIG. 7 is a screen view for final confirmation of the search conditions;

FIG. 8 is a screen view showing one example for displaying a search result; and

FIG. 9 is a screen view showing one example displaying a search result.

### DESCRIPTION OF THE PREFERRED EMBODIMENTS

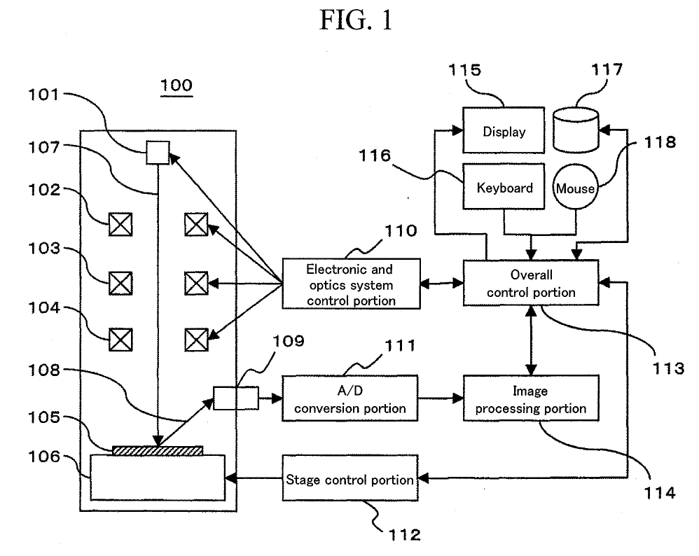

One example according to the present invention will be explained referring to drawings. FIG. 1 is a cross section showing a principal configuration of a SEM type defect reviewing apparatus. A main body 100 of the defect reviewing apparatus irradiates electron beams 107 emitted from an electron gun 101 onto a sample 105, and secondary particles 108 generated at the sample 105 are detected in a secondary particle detector 109. The electron beams 107 are focused by a lens 102, are deflected by a deflector 103 in such a way that the sample 105 is scanned, and are thinly narrowed onto the sample 105, using an object lens 104. The electron beams 107 are used in a vacuum, but environment-controlled portions such as a vacuum pump are eliminated in the drawing. The sample 105 is put on a stage 106, which is movable in the three axes direction, and movement and stopping of the stage 106 is controlled by a stage control portion 112.

The lens 102, the deflector 103, and the object lens 104 are controlled by a control portion 110 of an electron optical system. Secondary particles 108 such as secondary electrons, reflected electrons, X rays and the like are generated from the sample 105 irradiated by the electron beams 107 according to the shape and the material of a sample. The generated secondary particles 108 are detected by the secondary particle detector 109, are converted into digital signals in an A/D (analog to digital) conversion portion 111 by which an analog signal is converted into a digital signal to form a SEM image in an image processing portion 114. Moreover, image processing such as defect detection, contrast adjustment, and stereoscopic-image formation, is executed in the image processing portion 114, using the formed SEM image.

An overall control portion 113 interprets inputs from a keyboard 116, a mouse 118, and a memory device 117, which are connected to the portion 113, and controls the electronic and optics system control portion 110, the stage control portion 112, and an image processing portion 114. Moreover, various kinds of processes contents are output to a display 115 and the memory device 117, as required.

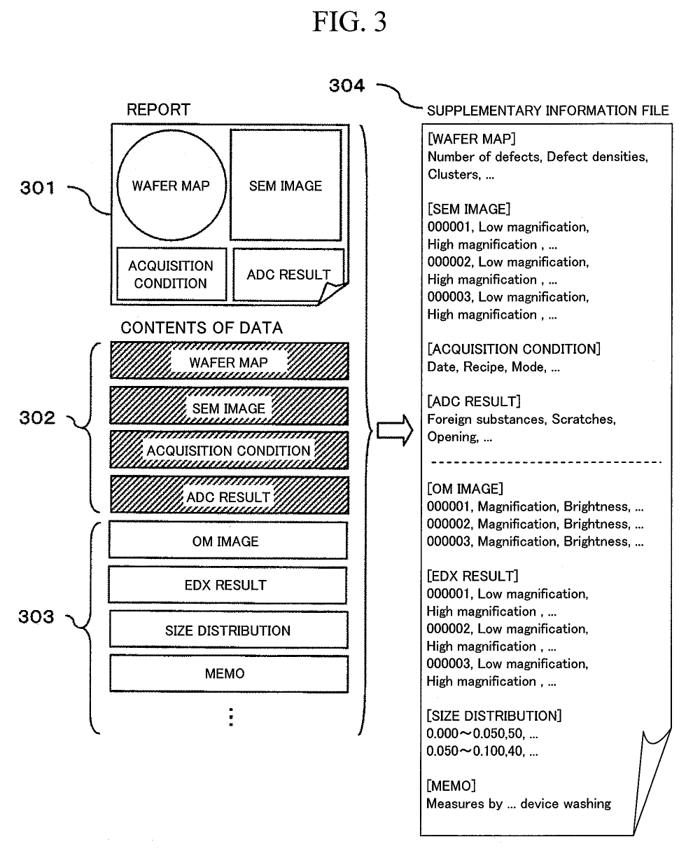

The defect reviewing apparatus receives the coordinate of a defect detected by the not-shown inspection device, and that of an alignment mark, detects the defect based on those coordinates, and preserves the coordinate and the classification result of the defect in the memory device 117, wherein the coordinate and the classification result are automatically or manually classified. Moreover, the defect reviewing apparatus also has a function by which a report is made from the classification result of the defect, and the data is memorized in the memory device 117. The contents of the report will be explained in detail when FIG. 3 is explained.

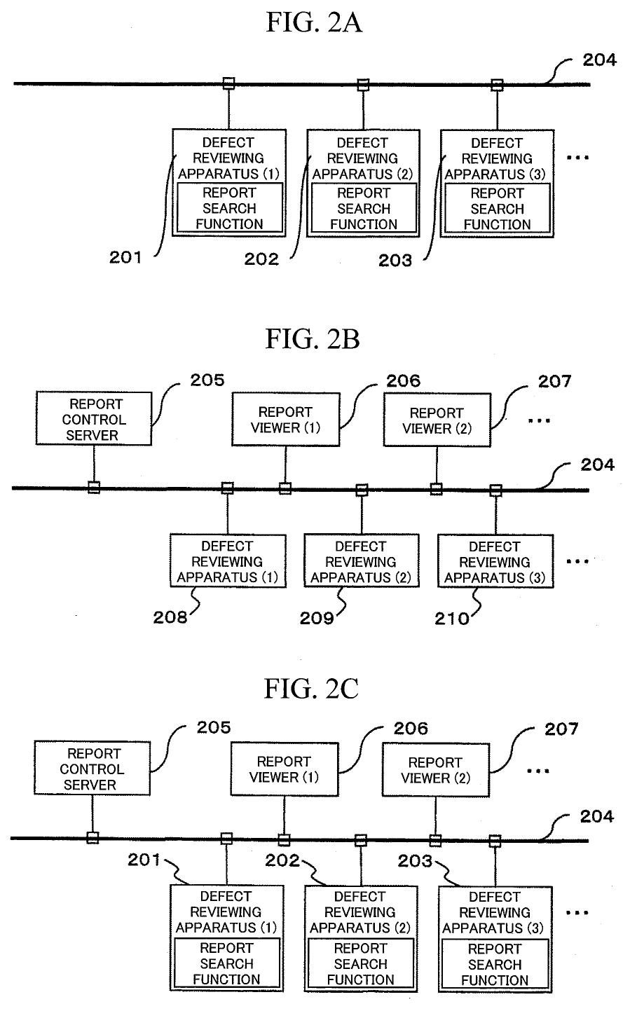

Each of FIG. 2A through FIG. 2C is a view of a system configuration connecting a plurality of defect reviewing apparatuses, and shows a case of a network configuration for a report search function. FIG. 2A shows a system in which a plurality of defect reviewing apparatuses 201, 202, and 203 are connected to each other through a network 204. FIG. 2B shows a system in which a report search function is not installed in a defect reviewing apparatus, there are provided report viewers 206 and 207, which are centrally controlled by a report control server 205 connected to a network 204, it is possible to access a report from a place other than the ones at which the reviewing apparatuses are provided. FIG. 2C shows a system in which the report search function is installed in a defect reviewing apparatus as well as FIG. 2A, and, moreover, there are provided a report control server 205 for collective control of reports, and, also, report viewers 206 and 207 through which it is possible to access a report from a place other than the ones at which the reviewing apparatuses are provided.

The example shown in FIG. 2A is a system which may reduce an initial investment because the report control server 205 as shown in FIG. 2B is not required to be introduced. However, each of the defect reviewing apparatuses is required to install the report search function. When only a small number of defect reviewing apparatuses are introduced in a manufacturing process for semiconductor devices, the above system comprehensively is an effective one in cost.

When it is assumed that a lot of defect reviewing apparatuses are introduced, it is preferable to adopt a system in which functions to make, preserve, and search reports are centrally controlled for a lot of defect reviewing apparatuses, using the report control server 205 shown in FIG. 2B, and FIG. 2C. When the report viewers 206 and 207 provided with a report search function are introduced, a report may be searched even from a place away from the sites at which the defect reviewing apparatuses and the report control server 205 are installed. In the system shown in FIG. 2C, a report may be searched by all the report searching functions in the report control server 205, the report viewers 206 and 207, and the defect reviewing apparatuses 201, 202, and 203.

FIG. 3 is an explanatory view showing the contents of a report file. Supplementary information on a defect is made into a file in the defect reviewing apparatus, main information set beforehand among supplementary information is displayed on an image 301, and, at the same time, is made into a report file as one unit. The supplementary information includes data contents 302 described in the report, and data contents 303 not described therein, and the both data is output as a supplementary information file in a state in which the file is supplemented with the report. It is determined beforehand whether information is described in a report. The output report is memorized in the memory device 117 of the defect reviewing apparatus making the report, and in a not-shown memory device of the report control server 205.

The data contents 302 described in the report are a wafer map, a SEM image, acquisition conditions, and ADC results. The data contents not described in the report are an OM image, an EDX result, size distributions, a memo, and the like, and include detailed data shown in a supplementary information file 304 shown in FIG. 3. Data forming one group in a plurality of items as one unit among the data is memorized as one group in a state in which each group has a name such as an ID (identification). For example, a data group having “000001” as an ID of “SEM image” in the supplementary information file in FIG. 3 represents supplementary information, such as a magnification value of an image acquired in a “low magnification value” and a magnification value of an image acquired in a “high magnification value”, on one defect in a SEM image. Here, it is acceptable to use time for report making, or starting time for searching a report as the timing for report making.

The reports memorized in the memory device 117 of the defect reviewing apparatus, and the not-shown memory device of the report control server 205 are searched by the report search function of the defect reviewing apparatus, using the report control server 205, and the report viewers 206 and 207.

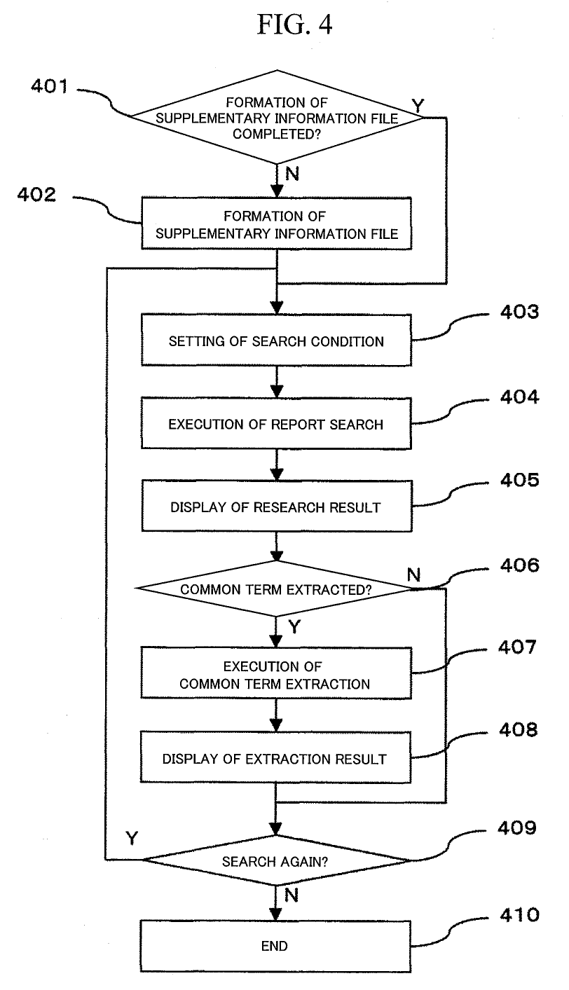

FIG. 4 is a flow chart showing the procedure of the report search. A report is searched by the report search function of the defect reviewing apparatus, using not-shown microprocessors in the report control server 205, and the report viewers 206 and 207. All the reports made in all the defect reviewing apparatuses connected to the network 204 may be searched even by the report search function in the defect reviewing apparatus, including those of the report control server 205, and the report viewers 206 and 207.

First, it is confirmed (step 401) by an instruction of an operator for start of report search whether supplementary information files have been made for all the reports memorized in the memory device 117 of defect reviewing apparatus and the not-shown memory device in the report control server 205. When not having been made, a supplementary information file is made (step 402). When an operator judges whether a supplementary information file has been made, the display 115 of the defect reviewing apparatus or the not shown display of the report control server 205, and the report viewers 206 and 207 are configured to display whether the supplementary information file has been made, and the processing goes to the next step based on judgement of the operator seeing the display.

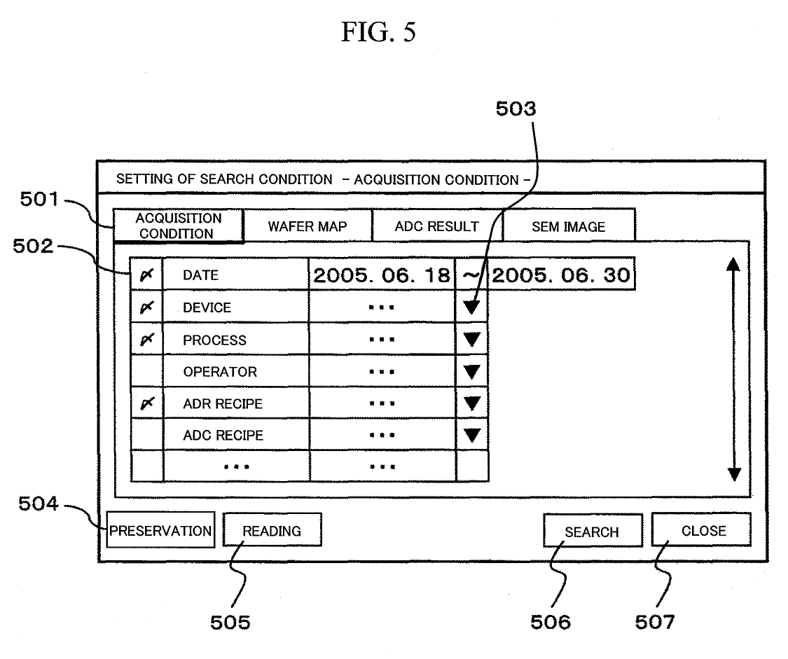

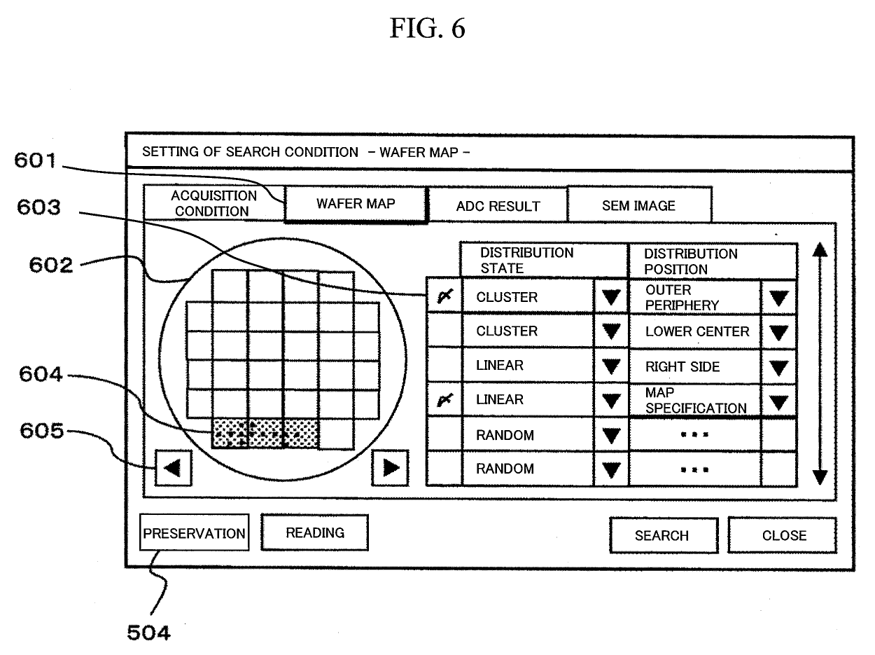

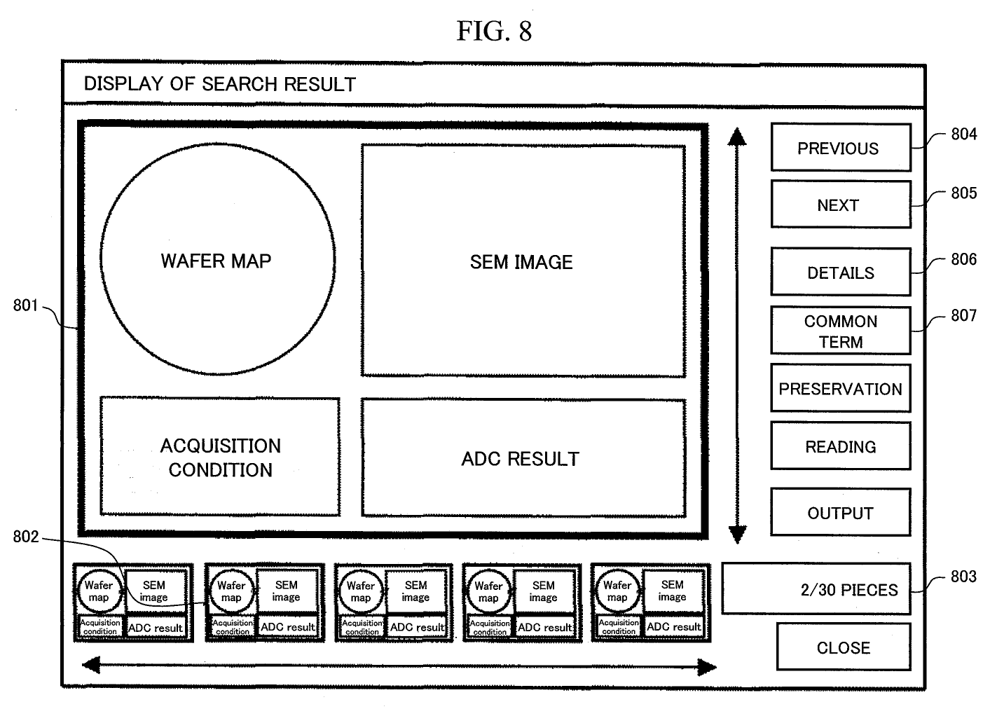

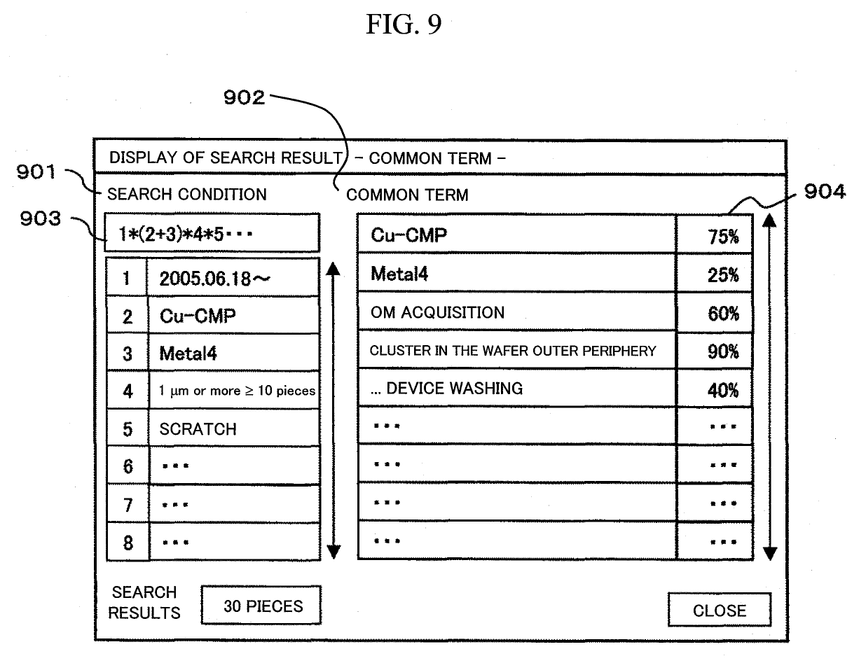

Then, the operator sets search conditions for the report (step 403). The set contents of the search conditions will be explained in detail referring to FIG. 5 or FIG. 6. Report search is executed (step 404) based on the set search conditions by the report search function of the defect reviewing apparatus, using the not-shown microprocessors in the report control server 205, and the report viewers 206 and 207. Then, search results are displayed (step 405) on the display 115 of the defect reviewing apparatus, or the not-shown display of the report control server 205, and those of the report viewers 206 and 207. The details of the displayed search result will be described when FIG. 8 or FIG. 9 is explained.

Though the search results displayed on the display have common search conditions, there are common terms other than the search conditions too. Accordingly, when there is a common term (step 406) which an operator instructs to display, a common term is extracted (step 407), and a result is displayed (step 408) as will be explained in detail referring to FIG. 9. When search is executed again after changing a search condition, the processing returns to a search condition setting step (step 403) based on an instruction by the operator (step 409) by use of a not-shown instruction screen for searching again. When search is not executed again, the processing is completed (step 410).

FIG. 5 is a screen view showing one example for displaying of a search condition setting. Items in the data contents 302 described in the report shown in FIG. 3 are displayed on the screen using tabs. When an acquisition condition tab 501 is specified, a data list for an acquisition condition is displayed as an acquisition condition list 502.

An operator puts a check mark on one of data to be selected as a search keyword, and a search condition is selected from a pull down list 503. In the example shown in FIG. 5, “date”, “device”, “process”, and “ADR recipe” are set as search keywords. With regard to “date”, “2005.06.18 through 2005.06.30” is specified as a search condition. A set search condition may be preserved by specifying a preservation button 504.

A preserved search condition may be read (or called) for display. When a check mark is put only on to, for example, “date” in the acquisition condition list 502, and a reading button 505 is specified, data having a “date” in agreement with the specified one, among the data preserved before, is displayed in the acquisition condition list 502.

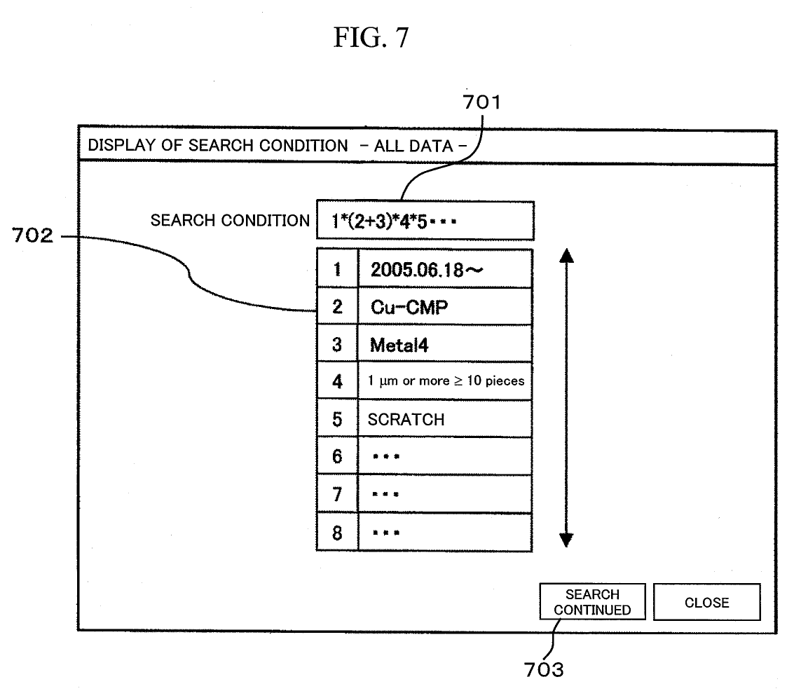

When a search condition as an acquisition condition is decided, a confirmation screen of the search condition is displayed as shown in FIG. 7 by instructing through the search button 506. When the report search is completed, the result is displayed on a search result display screen shown in FIG. 8. When the report search is stopped, a closing button 507 is specified.

FIG. 6 is a screen view showing one example for displaying of a search condition setting. Items in the data contents 302 described in the report shown in FIG. 3 are displayed on the screen, using tabs. When a wafer map tab 601 is specified, a data list on the wafer map, together with a wafer map 602, is displayed as a wafer map search condition list 603. Check marks are put on search conditions in the wafer map search condition list 603. When a cluster in the wafer outer portion is set as a search condition, “cluster” is selected in a pull down list of items on distributed states, and “outer” is selected in a pull down list of items on a distributed position in the example showing in the drawing.

Moreover, when a linear defect distribution on a wafer map is required to be specified in an area, “linear” is selected in a pull down list of items on distributed states, and “map specification” is selected in a pull down list of items on a distributed position for check marks. When “map specification” is selected, a place at which a defect is generated may be set, using a pointing device such as a mouse. For example, when an arbitrary position in a rectangle representing a die on the wafer map 602, the die is selected, and the selected die 604 is displayed based on the lightness or on the color, in order to distinguish the die from other dies.

The wafer map search condition is preserved by specification with the preservation button 504, and a plurality of preserved wafer map search conditions may be displayed in the preservation order by specification of a page up and down button 605.

Though an acquisition condition and a wafer map have been illustrated as data for setting a search condition, there are a SEM image, and an ADC result other than the above items as data described in a report, and there are an OM image, an EDX result, a size distribution, a memo and the like as data not described in a report as shown in FIG. 3. In the SEM image, a magnification and the presence of a defect are used as search keywords. In the case of the OM image, a magnification, the presence of an acquired image, the presence of a defect, and the like are used as a search keyword. A report on a past case in which a defect has not been detected in the SEM images, but has been detected in the OM images, may be searched by combination of search conditions of the SEM images and those of the OM images. The search conditions of the SEM images and those of the OM images may be combined for search by putting check marks to both a search keyword of the SEM image tab and that of the OM image tab.

When a generation frequency of a specific category and the like, which have been obtained after ADC execution, are used as a search keyword for a search condition of the ADC result, it becomes possible to search a report on a case which it has conventionally been difficult to search. For example, under a state in which a report includes a ratio of foreign substances to all defects it is possible by specifying data including foreign substances with a content of 60% or more to search a report on a case in which foreign substances with a content of 60% or more are included. Moreover, under a state in which a number of scratches is included as data on scratches in a report, it is possible by specifying data in which a number of scratches is equal to, or more than 10 pieces to search a report on a case in which the number of scratches is ten or more.

Generation cases of a specific element are used as one of search keywords for a search condition of the EDX result. There becomes possible search of reports specifying a relation between a foreign substance and the material by combination of the ADC result and the EDX result. For example, when a foreign substance is selected on a screen of a search condition for the ADC result, and aluminum is selected on a screen of a search condition for the EDX result, a report on a past case in which a defect having aluminum as a foreign substance has been generated may be searched.

The size distribution of the defects becomes a search keyword for a search condition of the size distribution. For example, when a defect size is preserved as data in a report and 1 μm or more is selected or is specified on a screen of a search condition for a size distribution, a report on a case of a defect with 1 μm or more may be searched. Moreover, a report of a case in which, for example, defects with a size of 0.3 μm through 0.6 μm make up 30% or more in all defects may be searched by preserving a size range, and a ratio containing the defects in all defects as data in a report. Moreover, when, for example, a scratch is specified on a screen of search conditions for an ADC result, and 1 μm or more is specified on a screen of search conditions for the size distribution for searching, a report of a past case in which scratches with a size of 1 μm or more are generated may be searched by combining the ADC result with the search condition of the size distribution.

Words and phrases in a comment registered in a report by an operator become a search keyword as a search condition in the memo. A report on a past case may be searched using a keyword such as an estimated cause, contents of a measure against the estimated cause, and a result of the measure. Thereby, a measure against a currently noteworthy problem may be examined referring to the past measure cases.

FIG. 7 is a screen view for final confirmation of a search condition. When a search button is specified on the screen shown in FIG. 5 and FIG. 6, a screen shown in FIG. 7 is displayed to show a search formula in a search formula display area 701, and search conditions in a search condition display area 702. The search formula is first displayed in a state that all the search conditions are united using “AND”, and may be changed into an arbitrary search formula by correcting the search formula in the search formula display area 701. When the search formula is determined, and a search continuation button 703 is specified, the search is executed.

FIG. 8 is a screen view showing one example for displaying of a search result. An image 801 of the searched report is displayed. When there are a plurality of searched reports, a report with the predetermined highest item order is displayed in the most enlarged image 801. Moreover, other reports, together with the image 801, may be seen as thumbnail display. An image 802 of a report selected with a thumbnail button is enlarged and displayed as the image 801. Moreover, the order of the image which is enlarged and displayed is displayed in an order display window 803. In the example of FIG. 8, the image 802 of the second report among thirty searched reports is enlarged and displayed as the image 801. There is another method for specifying the enlarged image 801, in which, when a previous button 804 is specified, an image to which a thumbnail image is returned by one image is enlarged and displayed as the image 801, and, when a next button 805 is specified, an image to which a thumbnail image is forwarded by one image is enlarged and displayed as the image 801. When a details button 806 is specified, the contents of a supplementary information file corresponding to the enlarged and displayed image 801 are overlapped and displayed on the image 801. Alternatively, switching may be performed in such a way that the contents of the supplementary information file are displayed all over the screen. The contents of the supplementary information file have the same format as that of the supplementary information file 304 shown in FIG. 3. When a common term button 807 is specified, an image shown in FIG. 9 is displayed.

FIG. 9 is a screen view showing one example for displaying of a search result. In some cases, data common to a plurality of searched reports includes data, which is not a search condition, other than a search condition. A table 901 showing the data as the search condition is shown on one side of the screen, and a table 902 of common data which is not the search condition is displayed on the other side of the screen. The search formula specified in FIG. 7 is displayed in a search formula display area 903. Among data shown as common data in the table 902, data common to all reports of 30 search results is displayed as 100%, and a percentage with regard to data common to a part of reports is displayed in a frequency display area 904.

The data shown as common data in the table 902 is data which has not been determined as common data when a search condition was set. According to a conventional technique, it is difficult to obtain information such as “cluster in the wafer outer portion”, and “ . . . device washing” in the table 902. But, the above information may be an effective one for examination of measures against a defective appearance.

Moreover, as the report viewers 206 and 207 may be provided at locations apart from a manufacturing process of a semiconductor device in the cases of systems shown in FIG. 2B and FIG. 2C, one viewer may be provided in, for example, a meeting room, which is used for examining measures, to quickly consider a measure by hearing opinions of a plurality of experts.

As a report on a result summarizing points of data on past cases of a defective appearance is searched as a search target as described above according to the present invention, it is possible to efficiently search required information without losing the required information in various kinds of information. Therefore, there may be made prompt measure against a defective appearance. As a report as a search result is output as the report was made in the past, it is possible to eliminate time for making the report. Moreover, when a desired image is searched among images, similarity search for images has been conventionally performed in some cases. Though the number of images is, for example, several hundreds in those cases, the number of data corresponding to that of those images is from several to several tens of data. As a search target is not an image, but data in the present invention, search may be performed in short period of time and with a high accuracy. Therefore, a measure against a defective appearance may be quickly made. Moreover, points which have been overlooked at report making, and information which has not been considered before search may be executed by a configuration in which, when a supplementary information file for a report is made, information not included in a report is memorized in a text form, and the above information not included in the above report may be used as a search keyword at search. As these pieces of information may be information useful for defective appearance analysis, the present invention is a very useful search system in comparison with a conventional technique.

What is claimed is:

1. A report search method, comprising the following steps of:
memorizing an image of a defective appearance and supplementary information on said image as a report file as one unit in a database for an observation result of the defective appearance of a sample in a manufacturing process;
searching said supplementary information as a search target among a plurality of report files memorized in said database by use of a search condition set from among said supplementary information when a new defective appearance is generated; and
outputting said searched supplementary information and an image related with said supplementary information.

2. A report search method, comprising the following steps of:
memorizing an image having a defective appearance, supplementary information, which is described in a report on said image, and supplementary information, which is not described in said report on said image, as a unit of a report file in a database for an observation result of a defective appearance of a sample at a manufacturing process;
searching both of supplementary information described in said report and supplementary information not described in said report as a search target among a plurality of report files memorized in said database, using a search condition set from among both of supplementary information described in said report, and supplementary information not described in said report, when a new defective appearance is generated; and
outputting an image related with searched supplementary information and supplementary information described in said report.

3. The report search method as claimed in claim 2, wherein supplementary information different from said search condition is output at said output step among pieces of supplementary information common to searched report files.

4. The report search method as claimed in claim 2, wherein
said search condition is set by combining a plurality of pieces of supplementary information among supplementary information described in said report and supplementary information not described in said report.

5. A reviewing apparatus, comprising:
a control portion which detects a defective appearance of a sample, makes a report file on an image having a defective appearance and the related supplementary information as a unit, and outputs predetermined supplementary information among said supplementary information and said image as a report; and
a memory device memorizing said report file, wherein
said control portion searches a report file memorized in said memory device using a search condition set from said supplementary information, and outputs supplementary information on a search result and an image related with said supplementary information, when a new defective appearance is generated.

6. The reviewing apparatus as claimed in claim 5, wherein
said control portion may search a reportfile, which is memorized in a memory device of another reviewing apparatus connected to a network, as a search target.

7. The reviewing apparatus as claimed in claim 5, wherein
said control portion searches both said predetermined supplementary information and the remaining supplementary information as a search target.

8. The reviewing apparatus as claimed in claim 5, wherein
said control portion outputs supplementary information different from said search condition among pieces of supplementary information common to searched report files.

9. A report search system, comprising:
a reviewing apparatus which detects a defective appearance and makes a report file on an image and the related supplementary information as a unit;
a database which is connected to said reviewing apparatus through a network, and memorizes said report file; and
a report viewer which searches a report file memorized in said database using a search condition set from said supplementary information, and displays searched supplementary information and an image related with said supplementary information on a display, when a new defective appearance is generated.
